(19) United States
(12) Patent Application Publication
(10) Pub. No.: US 2024/0378398 A1
(43) Pub. Date: Nov. 14, 2024

(54) REAL WORLD IMAGE DETECTION TO STORY GENERATION TO IMAGE GENERATION

(71) Applicant: Sony Interactive Entertainment Inc., Tokyo (JP)

(72) Inventor: Celeste Bean, San Mateo, CA (US)

(21) Appl. No.: 18/314,718

(22) Filed: May 9, 2023

(51) Int. Cl. G06F 40/40; G06T 11/00; G06V 10/764

(52) U.S. Cl. CPC G06F 40/40; G06T 11/00; G06V 10/764

(57) ABSTRACT

One or more objects in a user's real world (RW) environment are imaged and identified using a detection network such as a neural network. Indication of the identified object(s) is input to a generative neural network such as a generative pre-trained transformer (GPTT) to generate a short story about the object(s). The story can be segmented into chunks that are input to an image generator such as an application programming interface (API) to create images for stages of the story.

### FIELD

The present application relates generally to real world image detection of objects to generate stories related to the objects to in turn generate still or video images related to the stories.

### BACKGROUND

Present principles understand that the advent of generative neural networks has opened exciting new possibilities in video-based entertainment.

### SUMMARY

As understood herein, a story based on real world objects in a user's real-world environment can be generated along with accompanying pictures.

Accordingly, a system includes at least one computer medium that is not a transitory signal and that in turn includes instructions executable by at least one processor assembly to receive at least one image of at least one object in a real world (RW) environment. The instructions are executable to classify the object using a detection network, and input classification of the object to at least one generative neural network such as a generative pre-trained transformer (GPTT) to generate a text story about the object. Further, the instructions are executable to input at least a portion of the text story to an image generator which may be implemented by a diffusion model—image generator, to create at least one image related to the story. The instructions are executable to present the

In some embodiments the instructions can be executable to juxtapose with the image text from the story related to the image. In example implementations the instructions are executable to create plural images each associated with a respective segment of the story, and juxtapose with each image text from the respective segment of the story.

The detection network may include at least one neural network.

The instructions may be executable to segment the text story into chunks and input the chunks to the image generator to create at least one image for each chunk. The image generator can include at least one application programming interface (API) that may be associated with at least one machine learning (ML) model.

In another aspect, a method includes identifying at least one real world (RW) object. The method also includes, based at least in part on the identifying, using at least one neural network to generate a text story related to the object. Further, the method includes using at least one machine learning (ML) model, generating at least one image related to the story, and presenting the story and image on a video display.

In another aspect, an apparatus includes at least one camera, at least one processor assembly configured to execute machine vision on images from the camera of real-world objects to output indications of the images, and at least one generative neural network to receive the indications of the images and output a text story based thereon. The apparatus further includes at least one machine learning (ML) model to receive the story and generate at least one image based thereon. At least one display is provided to present the image along with at least a portion of the story pertaining to the image.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIG. 2 illustrates a game advice system employing a generative pre-trained transformer (GPTT) consistent with present principles;

FIG. 3 illustrates example logic in example flow chart format;

FIG. 4 illustrates an example computer system architecture;

FIG. 5 illustrates real world (RW) objects in a user's RW room;

FIG. 6 illustrates an example screen shot of an example story generated by a GPTT based on the RW object identities; and

FIGS. 7-9 illustrate example screen shots of chunks of the story in text form next to images related to the text.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or a client and server can be connected over a local intranet or a virtual private network. A server or controller may be instantiated by a game console such as a Sony PlayStation©, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

A processor may be a single- or multi-chip processor that can execute logic by means of various lines such as address lines, data lines, and control lines and registers and shift registers. A processor assembly may include one or more processors acting independently or in concert with each other to execute an algorithm.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

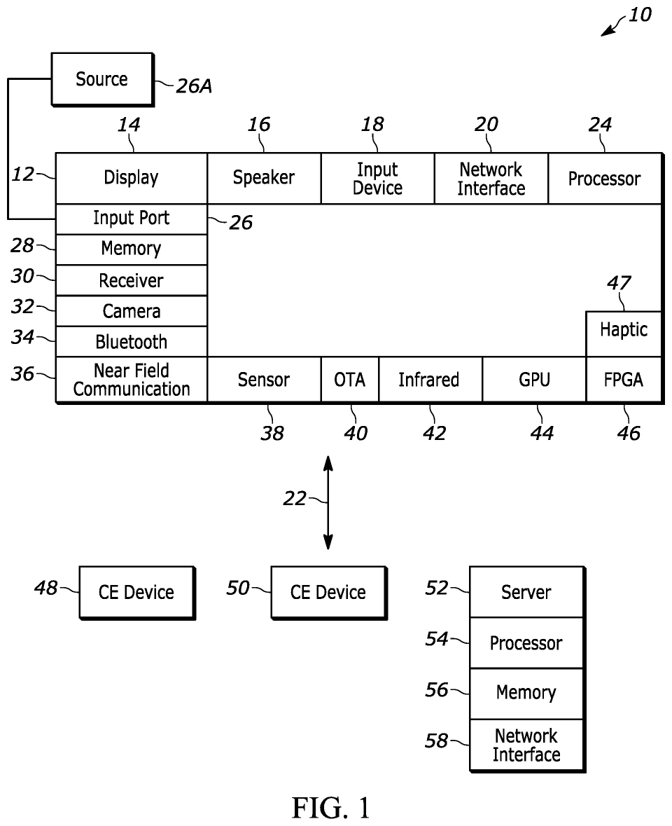

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). The AVD 12 alternatively may also be a computerized Internet enabled (“smart”) telephone, a tablet computer, a notebook computer, a HMD, a wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a USB port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a, when implemented as a game console, may include some or all of the components described below in relation to the CE device 48.

The AVD 12 may further include one or more computer memories 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command), providing input to the processor 24. The AVD 12 may include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics generators 47 may be provided for generating tactile signals that can be sensed by a person holding or in contact with the device.

Still referring to FIG. 1, in addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other devices of FIG. 1 over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown in FIG. 1 or nearby.

The components shown in the following figures may include some or all components shown in FIG. 1. The user interfaces (UI) described herein may be consolidated, expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Support vector machines (SVM) and Bayesian networks also may be considered to be examples of machine learning models. However, a preferred network contemplated herein is a generative pre-trained transformer (GPTT) that is trained using unsupervised training techniques described herein.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

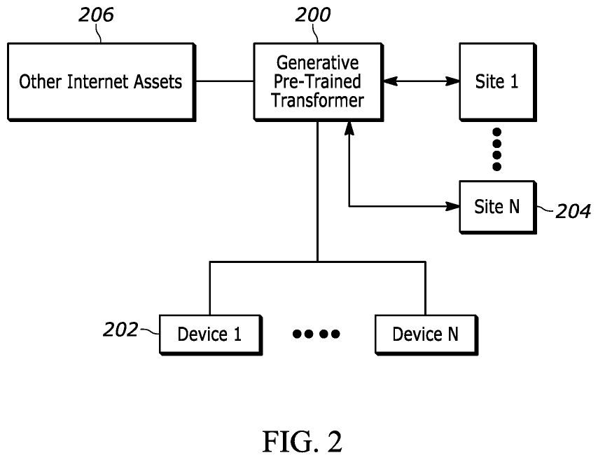

Turning to FIG. 2, in general, a generative pre-trained transformer (GPTT) 200 such as may be referred to as a “chatbot” receives queries from user computer devices 202 and based on being trained on a wide corpus of documents including real world object descriptions and stories related to objects various sites 204 such as social media sites as well as other Internet assets 206, returns a response in natural human language either spoken or written.

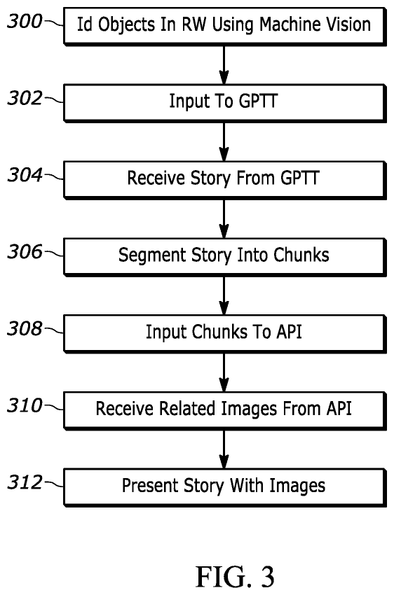

Now refer to FIG. 3. One or more cameras may generate images of one or more real world (RW) objects, for instance three objects in a room occupied by a computer user. The images may be processed through a machine vision-based object detection network, which may include one or more neural networks, at block 300 in FIG. 3 to identify or classify RW objects in the images. A non-limiting example of such a detection network with camera is an Nvidia Jetson Nano system running a RPi2 camera and ssd-mobilenet-v2 detection network.

Proceeding to block 302, the object identifications or classifications are sent to a generative neural network such as a generative pre-trained transformer (GPTT) to generate a story based on the identification/classification of one or more RW objects. To this end, the identifications/classifications may be input to an application programming interface (API) associated with the generative network. Non-limiting examples of generative networks that can be used include davinci-003 and ChatGPT3.5.

Proceeding to block 304, the story in text form is received from the generative network and at block 306 divided into text string sequences, referred to herein as “chunks”. Moving to block 308, the chunks are input to another API, this one associated with at least one machine learning (ML) model such as a diffusion model that creates images from text descriptions. Thus, for each chunk, a respective image is created reflecting the subject matter of the chunk. A non-limiting example of such a ML model with API is DALLE's API to create images for stages of the story using imagenet-001.

The images from the ML model are received at block 310. Block 312 indicates that the story in text form is presented on a display or is converted to audio and played on a speaker along with the images for each chunk. The images may be still images and/or video images and may be presented audibly.

For example, only the first chunk of the story may be presented along with the image created from the subject matter of that chunk. After a period of time or responsive to user input indicating the user is finished with the first chunk, the second chunk with associated image is presented, and so on. Or, particularly for shorter stories, the entire story may be presented and as the user scrolls through the story from chunk to chunk, the respective images are displayed. That is, as the user scrolls through the chunk, the image for the chunk the cursor currently is on is presented.

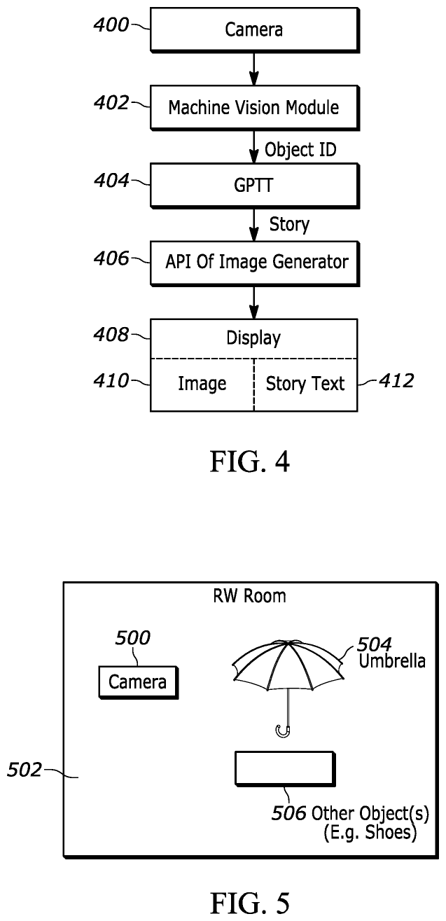

FIG. 4 illustrates an architecture consistent with the disclosure herein. One or more RW cameras 400 send images to one or more machine vision modules 402, which output descriptions or identifications or classifications of the objects to one or more generative networks 404. The text story output by the generative network 404 is sent to the API of the image generating ML model 406 such as a diffusion model. The model generates a still or video image for each story chunk, which is presented on a display 408 in a window 410 alongside the respective text 412 from whence the image was derived.

FIG. 5 illustrates one or more cameras 500 in a RW space 502 generating images of RW objects in the space 502. In the example shown, the RW objects include an umbrella 504 and other objects 506 such as shoes.

Assume for the following example description that “umbrella” and “shoes” are input to the generative network 404 shown in FIG. 4.

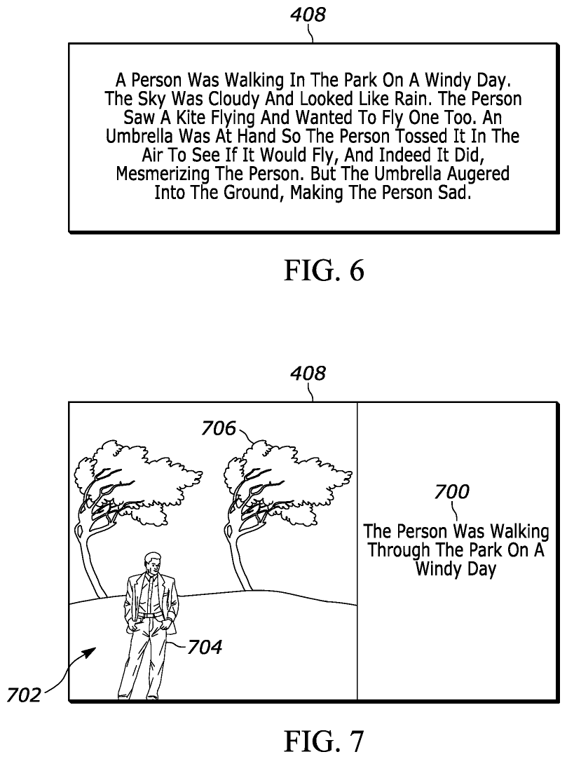

Now refer to FIG. 6. Text of a story is presented on the display 408 shown in FIG. 4. Note from the text that the story concerns a person walking in the park (derived from input of “shows”) who finds an umbrella and tosses it into the air to see if it will fly like a kite. According to the story, the umbrella briefly flies, mesmerizing the person, but eventually augers into the ground, making the person sad. The story is fanciful, in that the only two inputs to the generative models were “shoes” and “umbrella”.

FIGS. 7-9 illustrate the result of dividing the story into chunks and generating an image related to each chunk as described herein. In FIG. 7, text 700 of the first chunk is presented on the display, along with an image 702 of a person 704 walking through a park with trees 706 blowing in the wind.

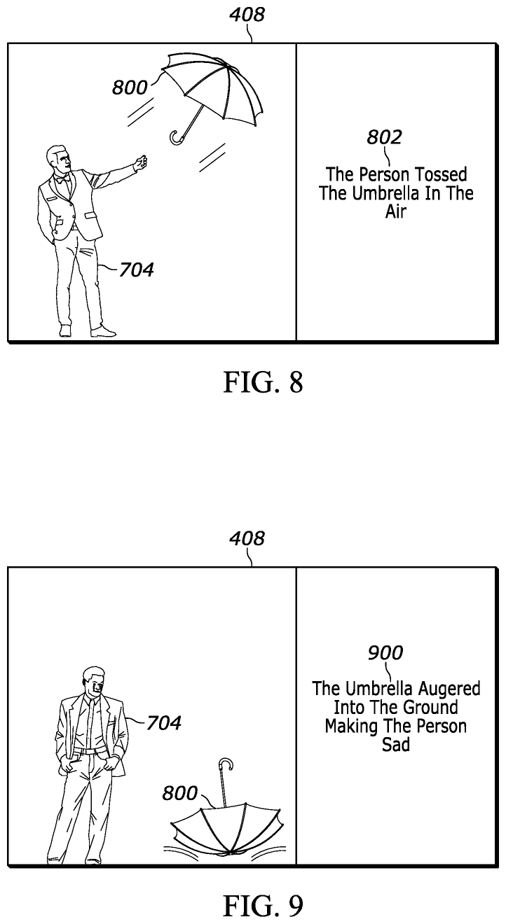

Then, once the user has scrolled through the first chunk to the second chunk and/or placed a cursor over the second chunk in the complete story shown in FIG. 6, FIG. 8 illustrates that an image of the person 704 appears tossing an umbrella 800 into the air, alongside text 802 of the second chunk of the story.

Yet again, once the user has scrolled through the second chunk to the third chunk and/or placed a cursor over the third chunk in the complete story shown in FIG. 6, FIG. 9 illustrates that an image of the person 704 appears with tears on her face, seeing the umbrella 800 crashed into the dirt, alongside text 900 of the third chunk of the story.

While the chunks are generally sequential from first to last through the story, they may or may not cumulatively make up the entire story. For example, assume a ninety-word story. The first chunk may be the first thirty words, the second chunk may be the second thirty words, and the third chunk may be the last thirty words. Or, the first chunk may be the first fifteen words, the second chunk may be a subset of the second thirty words, and the third chunk may be a subset of the last thirty words. Yet again, the chunks may overlap. As an example, the first chunk for which a first image is generated may be the first fifteen words (words 1-15), while the second chunk for which a second image is generated may be the tenth through twenty-fifth words (words 10-25), and so on.

The chunks may be of equal word count or unequal word count.

Yet again, each chunk of a story may be defined by a respective complete sentence of the story, to preserve context. The output of the GPTT or a separate context model may be used to indicate context within the story to avoid loss of context between images, with the chunks being generated based on context changes. Not all parts of a story may qualify as chunks to base images on. For example, sentences with action verbs may be designated as chunks and images generated based thereon, whereas sentences containing linking verbs may not quality as chunks to be input to the diffusion model to generate an image. The full story context may be input to the image generator along with the context of each particular chunk to base an image on. The image generator may be instructed to ensure images are consistent for the story, so that, for example, an umbrella in one image retains the same color as the umbrella in subsequent images.

While the particular embodiments are herein shown and described in detail, it is to be understood that the subject matter which is encompassed by the present invention is limited only by the claims.

What is claimed is:

1. A system comprising:
at least one computer medium that is not a transitory signal and that comprises instructions executable by at least one processor assembly to:
receive at least one image of at least one object in a real world (RW) environment;
classify the object using a detection network;
input classification of the object to at least one generative neural network to generate a text story about the object;
input at least a portion of the text story to an image generator to create at least one image related to the story; and
present the at least one image related to the story on at least one display.

2. The system of claim 1, comprising the at least one processor assembly.

3. The system of claim 1, wherein the instructions are executable to:
juxtapose with the at least one image text from the story related to the image.

4. The system of claim 3, wherein the instructions are executable to:
create plural images each associated with a respective segment of the story; and
juxtapose with each image text from the respective segment of the story.

5. The system of claim 1, wherein the detection network comprises at least one neural network.

6. The system of claim 1, wherein the instructions are executable to segment the text story into chunks and input the chunks to the image generator to create at least one image for each chunk.

7. The system of claim 6, wherein the image generator comprises at least one application programming interface (API).

8. The system of claim 7, wherein the API is associated with at least one machine learning (ML) model.

9. The system of claim 1, wherein the generative network comprises a generative pre-trained transformer (GPTT).

10. A method comprising:
identifying at least one real world (RW) object;
based at least in part on the identifying, using at least one neural network to generate a text story related to the object;
using at least one machine learning (ML) model, generating at least one image related to the story; and
presenting the story and image on a video display.

11. The method of claim 10, comprising
segmenting the story into chunks; and
inputting the chunks to the ML model to create at least one image for each chunk.

12. The method of claim 11, comprising:
presenting successive images on the video display along with the respective chunks to which each image pertains.

13. An apparatus, comprising:
at least one camera;
at least one processor assembly configured to execute machine vision on images from the camera of real-world objects to output indications of the images;
at least one generative neural network to receive the indications of the images and output a text story based thereon;
at least one machine learning (ML) model to receive the story and generate at least one image based thereon; and
at least one display to present the image along with at least a portion of the story pertaining to the image.

14. The apparatus of claim 13, wherein the ML model is configured to create plural images each associated with a respective segment of the story.

15. The apparatus of claim 13, wherein the processor is configured to execute machine learning using at least one neural network.

16. The apparatus of claim 13, wherein the ML model comprises at least one application programming interface (API).

17. The apparatus of claim 13, wherein the generative network comprises a generative pre-trained transformer (GPTT).

18. The apparatus of claim 17, wherein the GPTT is trained on a corpus of documents comprising object identifications.

19. The apparatus of claim 13, wherein the display is configured for presenting successive images along with the respective story segments to which each image pertains, the images changing as the story is scrolled through.
